(19) United States
(12) Patent Application Publication
(10) Pub. No.: US 2011/0147425 A1
(43) Pub. Date: Jun. 23, 2011

(54) VEHICLE EQUIPMENT MOUNT

(75) Inventor: John M. Di Miceli, Pomona, NY (US)

(73) Assignee: CONSOLIDATED EDISON COMPANY OF NEW YORK, INC., New York, NY (US)

(21) Appl. No.: 12/645,582

(22) Filed: Dec. 23, 2009

(51) Int. Cl. B60R 7/04; B60R 11/00

(52) U.S. Cl. 224/547; 224/548; 224/565

(57) ABSTRACT

A vehicle equipment mount for mounting one or more pieces of equipment within a vehicle, the vehicle equipment mount includes a base component that includes a floor plate, a middle plate, and an instrument mount plate, wherein the middle plate is movable with respect to the floor plate, and wherein the instrument mount plate connects with the middle plate. At least one first cradle connects to the instrument mount plate, the at least one first cradle being operable to hold a piece of equipment therein.

### BACKGROUND OF THE INVENTION

The present invention relates generally to the mounting of equipment in a vehicle, and more particularly to a vehicle equipment mount that enables relatively easy access by persons within the vehicle to various pieces of equipment located or mounted within the vehicle equipment mount.

Oftentimes employees (e.g., field technicians) of utility companies (e.g., gas, electric, etc.) drive around in a vehicle (e.g., a van) as part of their job responsibilities, where the vehicle contains specialized equipment that takes measurements, for example, it detects the presence of gas leaks in the geographic area in which the vehicle is being driven. The specialized equipment is not something that is typically standard equipment of the vehicle. Thus, the apparatus used to mount the equipment within the vehicle is also not usually standard equipment within the vehicle. Instead, the equipment and the mount are installed in the vehicle afterwards, typically by the utility company.

The specialized equipment may comprise various measurement devices (e.g., gas leak detectors), along with a power supply that powers the equipment and a computer and printer. The power supply, computer and printer may be connected to the vehicle battery or may include its own battery or other source of electrical power. Various types of mounting schemes are utilized to mount the various pieces of equipment within the vehicle. Preferably, the equipment mount within the vehicle should allow the vehicle driver or front seat passenger easy access to the equipment to (e.g., to view the equipment display) while at the same time not interfering with the ability of the driver to safely drive the vehicle.

Thus, while existing vehicle equipment mounts are somewhat suitable for their intended purposes, there remains a need for improvements in such vehicle equipment mounts. In particular, there remains a need for improvements in providing a vehicle equipment mount that allows for relatively easy and safe access by persons within the vehicle to various pieces of equipment located within the vehicle equipment mount.

### SUMMARY OF THE INVENTION

According to an aspect of the present invention, a vehicle equipment mount for mounting one or more pieces of equipment within a vehicle, the vehicle equipment mount includes a base component that includes a floor plate, a middle plate, and an instrument mount plate, wherein the middle plate is movable with respect to the floor plate, and wherein the instrument mount plate connects with the middle plate. At least one first cradle connects to the instrument mount plate, the at least one first cradle being operable to hold a piece of equipment therein.

According to another aspect of the present invention, a vehicle equipment mount for mounting one or more pieces of equipment within a vehicle, the vehicle equipment mount includes a floor plate, a middle plate, an instrument mount plate, and at least one first cradle that connects to the instrument mount plate, the at least one cradle being operable to hold a piece of equipment therein.

According to yet another aspect of the present invention, a vehicle equipment mount for mounting one or more pieces of equipment within a vehicle, the vehicle equipment mount includes a base component that includes a floor plate, a middle plate, and an instrument mount plate. The vehicle equipment mount further includes at least one first cradle that connects to the base component, the at least one cradle being operable to hold a piece of equipment therein, and at least one second cradle that connects with the base component; the at least one second cradle being operable to hold a piece of equipment therein.

### BRIEF DESCRIPTION OF THE DRAWINGS

Referring now to the drawings, which are meant to be exemplary and not limiting, and wherein like elements are numbered alike:

FIG. 1 is a top plan view of a bottom or floor plate that is part of the vehicle equipment mount according to an embodiment of the present invention;

FIG. 2 is a cross section view of the bottom or floor plate of FIG. 1 that is part of the vehicle equipment mount according to an embodiment of the present invention;

FIG. 3 is a top plan view of a middle or roller plate that is part of the vehicle equipment mount according to an embodiment of the present invention;

FIG. 4 is a cross section view of the middle or roller plate of FIG. 3 that is part of the vehicle equipment mount according to an embodiment of the present invention;

FIG. 5 is a top plan view of a top or instrument mount plate that is part of the vehicle equipment mount according to an embodiment of the present invention;

FIG. 6 is a top plan view of the plates of FIGS. 1-5 connected together to form a base component of the vehicle equipment mount according to an embodiment of the present invention;

FIG. 7 is a cross section view of the base component of the vehicle equipment mount according to an embodiment of the present invention;

FIG. 8 is a top plan view of a template of a mounting cradle that is part of the vehicle equipment mount according to an embodiment of the present invention;

FIG. 9 is a perspective view of the mounting cradle of FIG. 8 that is part of the vehicle equipment mount according to an embodiment of the present invention;

FIG. 10 is a top plan view of a second mounting cradle that is part of the vehicle equipment mount according to an embodiment of the present invention;

FIG. 11 is a side view of the second mounting cradle of FIG. 10 that is part of the vehicle equipment mount according to an embodiment of the present invention;

FIG. 12 is a front view of the second mounting cradle of FIG. 10 that is part of the vehicle equipment mount according to an embodiment of the present invention;

FIG. 13 is a perspective view of the second mounting cradle of FIG. 10 that is part of the vehicle equipment mount according to an embodiment of the present invention; and

FIG. 14 is a perspective view of the base, and the first and second mounting cradles assembled together into the vehicle equipment mount according to an embodiment of the present invention and with various pieces of measuring equipment mounted thereto.

### DETAILED DESCRIPTION OF THE INVENTION

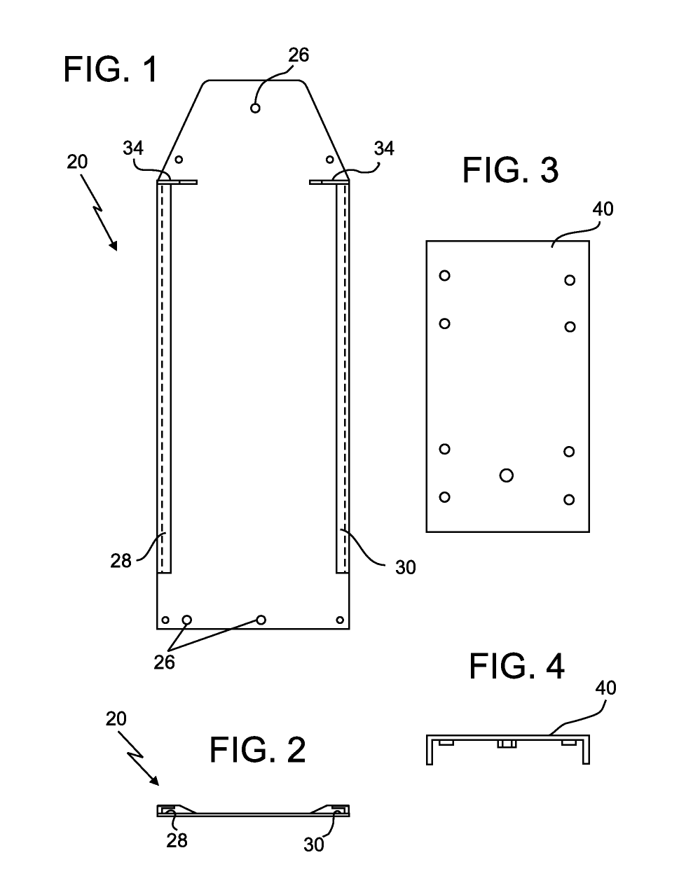

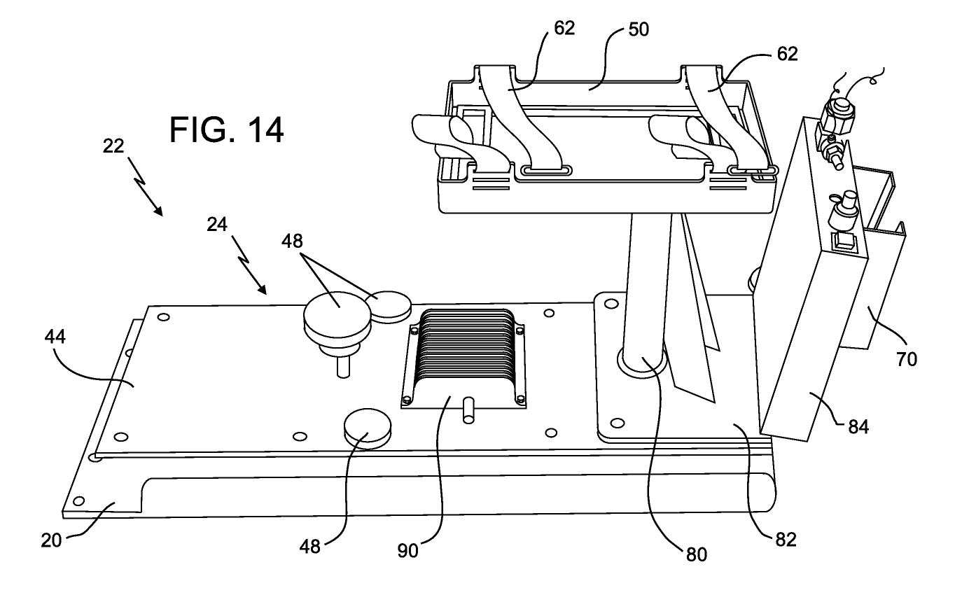

Referring to FIGS. 1 and 2, there illustrated are top plan and cross section views, respectively, of a bottom or floor plate 20 that is part of the vehicle equipment mount 22 (FIG. 14) according to an embodiment of the present invention. The floor plate 20 may comprise steel or other suitable material. The floor plate 20 may be one component of a base component 24 (FIGS. 6 and 7), described in detail hereinafter. The floor plate 20 may be mounted to the floor or some other portion of a vehicle in a desired location (e.g., between the two front seats) using a plurality of bolts that fit through a corresponding plurality of holes 26 located in the floor plate 20. Located along a portion of the left and right edges of the floor plate 20 (as viewed in FIG. 1) are L-channels 28, 30 in which rollers 32 (FIGS. 6 and 7) may move back-and-forth within, as described in detail hereinafter. Each L-channel 28, 30 may have a stop 34 located at one end of the channel 28, 30 to limit the movement of the rollers 32 in one direction.

Referring to FIGS. 3 and 4, there illustrated are top plan and cross section views, respectively, of a middle or roller plate 40 that is part of the vehicle equipment mount 22 according to an embodiment of the present invention. The roller plate 40 may also comprise steel or other suitable material. Although not shown in FIGS. 3 and 4, but shown in FIGS. 6 and 7, the roller plate 40 has the rollers 32 attached thereto for back-and-forth movement in the L-channels 28, 30 of the floor plate 20. Other devices besides rollers 32 may be utilized to facilitate movement of the roller plate 40 with respect to the floor plate 20.

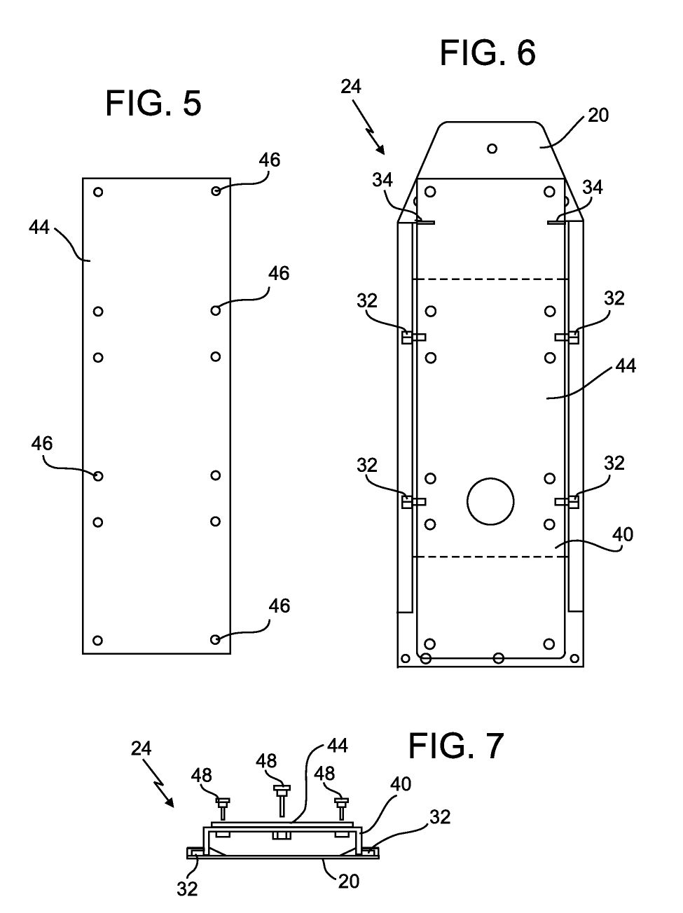

Referring to FIG. 5, there illustrated is a top plan view of a top or instrument mount plate 44 that is part of the vehicle equipment mount 22 according to an embodiment of the present invention. The instrument mount plate 44 may comprise a relatively flat piece of steel or other suitable material. The instrument mount plate 44 may have a number of holes 46 that facilitate the mounting to that plate 44 of various pieces of equipment along with set screws (FIG. 14), and for also mounting the instrument mount plate 44 to the middle roller plate 40.

Referring to FIGS. 6 and 7, there illustrated are top plan and cross section views of the plates 20, 40, 44 of FIGS. 1-5 connected together to form the base component 24 of the vehicle equipment mount 22 according to an embodiment of the present invention. As shown in FIG. 7, a number of set screws 48 may be utilized to secure the top instrument mount plate 44 to the middle or roller plate 40. The top and bottom ends of the middle or roller plate 40 are shown in dotted lines in FIG. 6. In use, the base component 24 is mounted to the floor or some other portion of a vehicle using, e.g., screws, to bolt the bottom or floor plate 20 to the vehicle. The instrument or top plate 44 is connected to the middle or roller plate 40, and the two plates 40, 44 move back-and-forth within the L-channels 28, 30 in the floor plate 20 by way of the rollers 32. Various pieces of equipment are attached to the base component 24, as described in detail hereinafter.

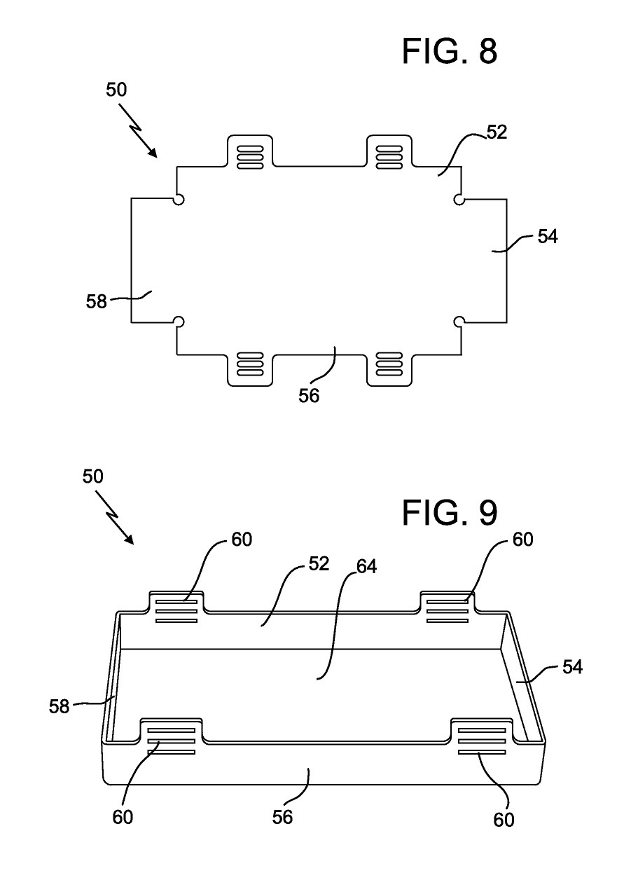

Referring to FIGS. 8 and 9, there illustrated are a top plan view of a template of a mounting cradle 50, and a perspective view of the resulting mounting cradle 50, respectively, that is part of the vehicle equipment mount 22 according to an embodiment of the present invention. The mounting cradle 50 may comprise aluminum, steel or other suitable material. The template may be cut or punched out of a sheet of stock material. The template may then have the four sides 52-58 folded up and the corners or junctions of the sides may be connected by welding or some other suitable means. In two of the sides 52, 56 are formed a plurality of elongated slots 60 that allow Velcro straps 62 (FIG. 14) to pass through. A piece of equipment (e.g., a gas leak detection device) may be placed in an interior portion 64 of the mounting cradle 50 and secured in place by the Velcro straps.

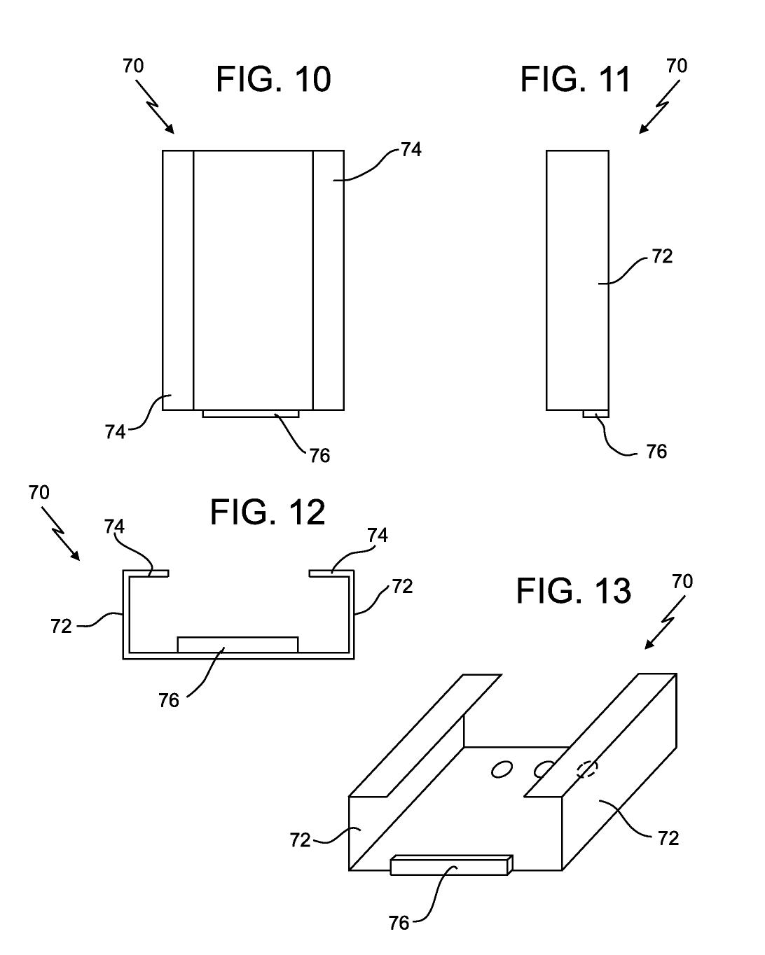

Referring to FIGS. 10-13, there illustrated are top plan, side, front and perspective views, respectively, of a second mounting cradle 70 that is part of the vehicle equipment mount 22 according to an embodiment of the present invention. The second mounting cradle 70 may comprise aluminum, steel or other suitable material. The second mounting cradle may have a pair of side walls 72 that fold over to include top portions 74. A stop 76 may be provided at one end cradle 70 to prevent a piece of equipment that may be placed in the cradle 70 from traveling beyond the end of the cradle with the stop 76.

Referring to FIG. 14, there illustrated is a perspective view of the base component 24, and the first and second mounting cradles 50, 70 assembled together into the vehicle equipment mount 22 according to an embodiment of the present invention and with various pieces of measuring equipment and support equipment therefore mounted thereto. A pedestal 80 on which is mounted the first mounting cradle 50 may be included. A bottom plate 82 of the pedestal 80 may be secured to the top or instrument mount plate 44 of the base component 24 by, e.g., screws. However, the pedestal 80 is optional and instead the first mounting cradle 50 may be attached directly to the instrument mount plate 44 without use of the pedestal 80.

A piece of electronic equipment 84 may also be mounted somewhat vertically (i.e., at a slight incline angle), as seen in FIG. 14, to the bottom plate 82 of the pedestal 80 or to the top or instrument mounting plate 44 by, e.g., screws or set screws. The second mounting cradle 70 may then be mounted to the piece of electronic equipment 84 by, e.g., screws. However, the piece of electronic equipment 84 is optional. The second mounting cradle 70 may instead be directly mounted to the instrument mounting plate 44 or to the floor plate 20. Although not shown in FIG. 14, a piece of electronic equipment (e.g., a gas leak detector) may be located within the first mounting cradle 50, while another piece of electronic equipment may be located within the second mounting cradle 70. As the second mounting cradle 70 is oriented primarily vertically when the vehicle equipment mount of an embodiment of the present invention is mounted within the vehicle, this cradle 70 is well suited for equipment in which the display panel and controls are located on one side such that the user can easily access and/or view the display panel and controls. A power supply 90 is shown mounted to the instrument plate 44.

While the invention has been described with reference to exemplary embodiments, it will be understood that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A vehicle equipment mount for mounting one or more pieces of equipment within a vehicle, the vehicle equipment mount comprising:
a base component that includes
a floor plate;
a middle plate; and
an instrument mount plate, wherein the middle plate is movable with respect to the floor plate, and wherein the instrument mount plate connects with the middle plate; and
at least one first cradle that connects to the instrument mount plate, the at least one cradle being operable to hold a piece of equipment therein.

2. The vehicle equipment mount of claim 1, wherein the floor plate is mounted to a vehicle at a desired location within the vehicle.

3. The vehicle equipment mount of claim 1, further comprising one or more rollers that allow the middle plate to move with respect to the floor plate.

4. The vehicle equipment mount of claim 1, further comprising at least one second cradle that connects with the base component.

5. The vehicle equipment mount of claim 4, wherein the at least one second cradle connects with a piece of equipment that is connected with the base component.

6. The vehicle equipment mount of claim 1, further comprising a pedestal mounted to the instrument mount plate, wherein the at least one first cradle mounts to the pedestal.

7. The vehicle equipment mount of claim 1, wherein the at least one first cradle includes one or more straps for holding a piece of equipment within the at least one first cradle.

8. A vehicle equipment mount for mounting one or more pieces of equipment within a vehicle, the vehicle equipment mount comprising:
a floor plate;
a middle plate;
an instrument mount plate; and
at least one first cradle that connects to the instrument mount plate, the at least one cradle being operable to hold a piece of equipment therein.

9. The vehicle equipment mount of claim 8, wherein the middle plate is movable with respect to the floor plate.

10. The vehicle equipment mount of claim 8, wherein the instrument mount plate connects with the middle plate.

11. The vehicle equipment mount of claim 8, wherein the floor plate, the middle plate and the instrument mount plate comprise a base component, wherein the base component is mounted to a vehicle at a desired location within the vehicle.

12. The vehicle equipment mount of claim 8, further comprising one or more rollers that allow the middle plate to move with respect to the floor plate.

13. The vehicle equipment mount of claim 8, further comprising at least one second cradle that connects with the base component.

14. The vehicle equipment mount of claim 8, further comprising a pedestal mounted to the instrument mount plate, wherein the at least one first cradle mounts to the pedestal.

15. A vehicle equipment mount for mounting one or more pieces of equipment within a vehicle, the vehicle equipment mount comprising:
a base component that includes
a floor plate;
a middle plate; and
an instrument mount plate;
at least one first cradle that connects to the base component, the at least one cradle being operable to hold a piece of equipment therein; and
at least one second cradle that connects with the base component; the at least one second cradle being operable to hold a piece of equipment therein.

16. The vehicle equipment mount of claim 15, wherein the middle plate is movable with respect to the floor plate.

17. The vehicle equipment mount of claim 15, wherein the instrument mount plate connects with the middle plate.

18. The vehicle equipment mount of claim 15, further comprising one or more rollers that allow the middle plate to move with respect to the floor plate.

19. The vehicle equipment mount of claim 15, further comprising a pedestal mounted to the instrument mount plate, wherein the at least one first cradle mounts to the pedestal.

20. The vehicle equipment mount of claim 15, wherein the at least one second cradle connects with a piece of equipment that is connected with the base component.
